(19) United States
(12) Patent Application Publication
(10) Pub. No.: US 2018/0073945 A1
(43) Pub. Date: Mar. 15, 2018

(54) External Force Measurement System for Work Machine, and Work Machine

(71) Applicant: Hitachi, Ltd., Chiyoda-ku, Tokyo (JP)

(72) Inventors: Takamasa KAI, Tokyo (JP); Hiroyuki YAMADA, Tokyo (JP); Saku EGAWA, Tokyo (JP)

(21) Appl. No.: 15/564,479

(22) PCT Filed: Mar. 9, 2016
(86) PCT No.: PCT/JP2016/057262

§ 371 Date: Oct. 5, 2017

(30) Foreign Application Priority Data
Apr. 6, 2015 (JP) 2015-077314

(51) Int. Cl. G01L 1/22; E02F 9/26; E02F 9/22; G01G 3/14; G01L 5/00

(52) U.S. Cl. CPC G01L 1/2287; E02F 9/26; G01N 3/24; G01G 3/1408; G01L 5/0061; E02F 9/2221

(57) ABSTRACT

External force acting on a hydraulic excavator bucket is calculated precisely. An external force measurement system for a work machine includes a hydraulic cylinder for driving a front unit of the work machine and a plurality of strain gauges for sensing strain amounts of a cylinder rod of the hydraulic cylinder. The plurality of strain gauges are formed of at least two sets of strain gauges. The at least two sets of strain gauges are arranged to oppose each other as viewed in an axial direction of the cylinder rod. The external force measurement system includes a load calculation section that is configured to calculate a load acting on the hydraulic cylinder based on difference between the strain amounts of the strain gauges arranged to oppose each other in each set.

### TECHNICAL FIELD

The present invention relates to an external force measurement system for a work machine and to a work machine.

### BACKGROUND ART

There has been known a technology for calculating excavation quantity and excavation reaction force of a hydraulic excavator. In Patent Document 1, for example, a Lagrange equation of motion for obtaining a reaction load acting on a point of action is derived in regard to each link, and the rotation angle of each link is detected while also estimating torque around a pivot axis on the heavy machinery body's side of each link. The reaction load is calculated by solving the Lagrange equation of motion based on those values. Based on the reaction load, a reaction load that a tip end link receives from an object at the point of action is calculated.

### PRIOR ART DOCUMENT

### Patent Document

Patent Document 1: JP-2013-108907-A

### SUMMARY OF THE INVENTION

### Problem to be Solved by the Invention

In the technology of Patent Document 1, the reaction load is calculated by estimating the torque around the pivot axis on the heavy machinery body's side of each link and solving the equation of motion, and axial force acting on a cylinder rod is measured by using two strain gauges in order to calculate the torque. However, in cases where strain gauges are applied to a cylinder rod as in Patent Document 1, it is difficult to precisely measure the reaction load due to influence of a moment load at times of swinging and an impact load at times of excavation.

The object of the present invention is to precisely calculate external force acting on a hydraulic excavator bucket.

### Means for Solving the Problem

Features of the present invention for resolving the above-described problem are as follows, for example:

An external force measurement system for a work machine includes a hydraulic cylinder for driving a front unit of the work machine and a plurality of strain gauges for sensing strain amounts of a cylinder rod of the hydraulic cylinder. The plurality of strain gauges are formed of at least two sets of strain gauges. The at least two sets of strain gauges are arranged to oppose each other as viewed in an axial direction of the cylinder rod. The external force measurement system includes a load calculation section that is configured to calculate a load acting on the hydraulic cylinder based on difference between the strain amounts of the strain gauges arranged to oppose each other in each set.

An external force measurement system for a work machine includes a hydraulic cylinder for driving a front unit of the work machine and a plurality of strain gauges for sensing strain amounts of a cylinder rod of the hydraulic cylinder. The plurality of strain gauges are formed of at least two sets of strain gauges. The at least two sets of strain gauges are arranged to oppose each other as viewed in an axial direction of the cylinder rod. The external force measurement system includes a load calculation section that is configured to calculate a load acting on the hydraulic cylinder based on an average value of the strain amounts of the at least two sets of strain gauges.

A work machine includes a hydraulic cylinder for driving a front unit of the work machine and a plurality of strain gauges for sensing strain amounts of a cylinder rod of the hydraulic cylinder. The plurality of strain gauges are formed of at least two sets of strain gauges. The at least two sets of strain gauges are arranged to oppose each other as viewed in an axial direction of the cylinder rod.

### Effect of the Invention

According to the present invention, the external force acting on the hydraulic excavator bucket can be calculated precisely. Problems, configurations and effects other than those described above will be clarified in the following description of the embodiments.

### BRIEF DESCRIPTION OF THE DRAWINGS

FIG. 1 is an overall view of a hydraulic excavator.

FIG. 2 is an enlarged view of a cylinder rod.

FIG. 3 is a cross-sectional view of a cylinder rod with strain gauges.

FIG. 4 is a work flow chart of a load calculation section.

FIG. 5 is an enlarged view of an excavator front unit.

FIG. 6 is a cross-sectional view of a cylinder rod with strain gauges.

### MODES FOR CARRYING OUT THE INVENTION

Referring now to the drawings, descriptions will be given in detail of preferred embodiments in accordance with the present invention. The following description will be given for illustrating specific examples of the contents of the present invention, and thus the present invention is not to be restricted to the description of those specific examples. A variety of modifications and corrections by those skilled in the art are possible within the scope of technical ideas disclosed in this description. Incidentally, elements having the same function are assigned the same reference character throughout the drawings for illustrating the present invention and repeated explanation thereof can be omitted for brevity.

### First Embodiment

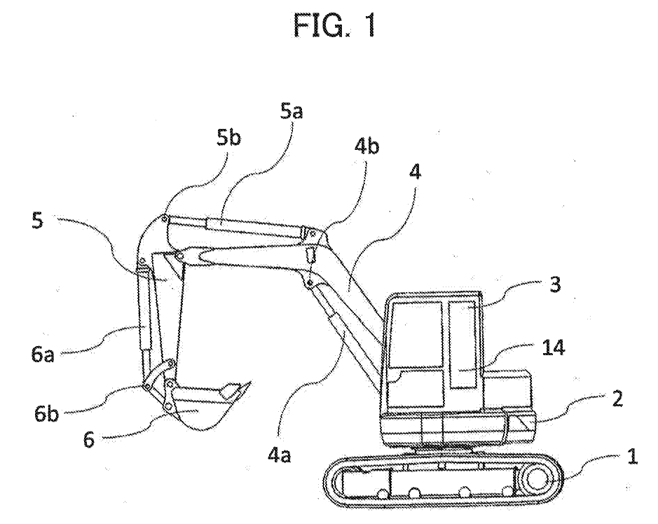

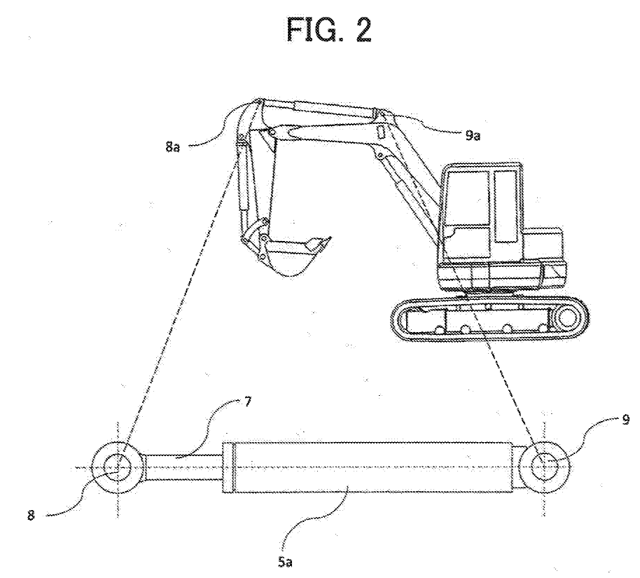

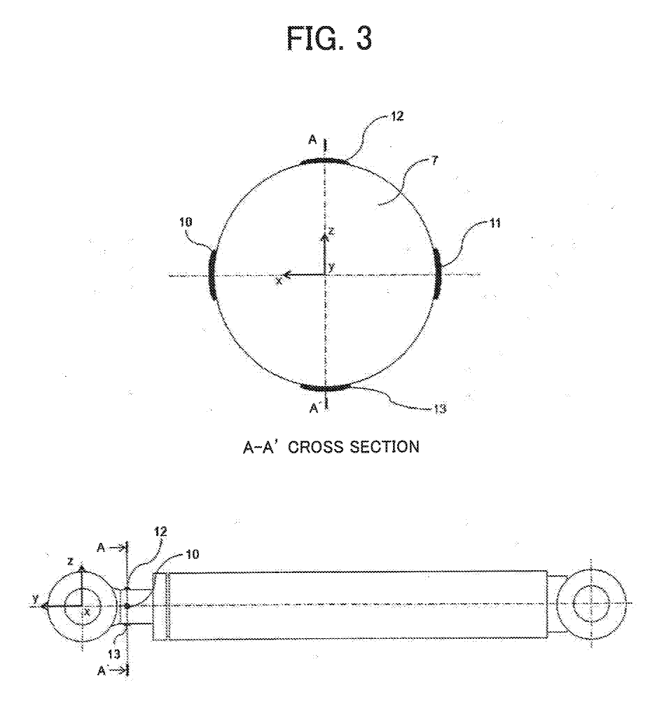

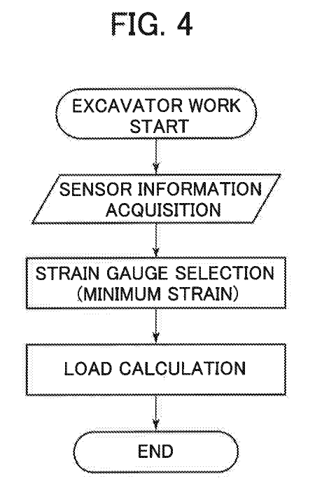

In this embodiment, the following description will be given by assuming a hydraulic excavator as the work machine and a bucket as an attachment on which external force acts. A method of measuring the external force acting on the bucket during work with the hydraulic excavator will be described below with reference to FIGS. 1, 2, 3 and 4. FIG. 1 is an overall view of the hydraulic excavator. FIG. 2 is an enlarged view of a cylinder rod. FIG. 3 is a cross-sectional view of a cylinder rod with strain gauges. FIG. 4 is a work flow chart of a load calculation section.

Features of this embodiment are as follows: An external force measurement system for a work machine includes a hydraulic cylinder for driving a front unit of the work machine and a plurality of strain gauges for sensing strain amounts of a cylinder rod of the hydraulic cylinder. The plurality of strain gauges are formed of at least two sets of strain gauges. The at least two sets of strain gauges are arranged to oppose each other as viewed in an axial direction of the cylinder rod. The external force measurement system includes a load calculation section that is configured to calculate a load acting on the hydraulic cylinder based on difference between the strain amounts of the strain gauges arranged to oppose each other in each set.

The hydraulic excavator 100 includes a lower track structure 1 shown in FIG. 1, an upper swing structure 2 attached to the top of the lower track structure 1, a cab 3 attached to the upper swing structure 2, a boom 4 attached to the upper swing structure 2, an arm 5 attached to the tip end of the boom 4, and a bucket 6 attached to the tip end of the arm 5. A front unit is formed of the boom 4, the arm 5 and the bucket 6.

A boom cylinder 4a, an arm cylinder 5a and a bucket cylinder 6a as hydraulic cylinders are respectively attached to the boom 4, the arm 5 and the bucket 6. Further, a boom stroke sensor 4b, an arm stroke sensor 5b and a bucket stroke sensor 6b are respectively attached to the boom 4, the arm 5 and the bucket 6. Each of these hydraulic cylinders can be expanded and contracted by operating a control lever arranged in the cab 3 and thereby adjusting the amount of hydraulic fluid in the cylinder. The boom 4, the arm 5 and the bucket 6 (front unit) can be driven by the expanding/contracting operation of the hydraulic cylinders. A load calculation section 20 for calculating the load acting on each hydraulic cylinder is arranged in the cab 3. The load calculation section 20 may also be arranged outside the hydraulic excavator 100 as the external force measurement system for the work machine.

FIG. 2 is an enlarged view of a hydraulic cylinder. While the arm cylinder 5a will be explained here, the boom cylinder 4a and the bucket cylinder 6a are also equivalent in the configuration. The hydraulic cylinder 5a is connected to the arm 5 by inserting a pin into an insertion hole 8a of the arm 5 and a clevis 8. Similarly, the other end of the hydraulic cylinder is connected to the boom 4 by inserting a pin into an insertion hole 9a of the boom 4 and a clevis 9. With the hydraulic cylinder 5a attached as above, an operation of folding the arm 5 to the cab 3's side (crowding operation) can be performed when the hydraulic cylinder 5a expands, and an operation of extending the arm 5 (damping operation) can be performed when the hydraulic cylinder 5a contracts.

Similarly to the arm 5, the bucket 6 performs a crowding operation when the hydraulic cylinder 6a expands, and performs a damping operation when the hydraulic cylinder 6a contracts. The boom 4 performs a boom raising operation when the boom cylinder 4a expands, and performs a boom lowering operation when the boom cylinder 4a contracts.

FIG. 3 is a cross-sectional view of a cylinder rod, which is common to the boom cylinder 4a, the arm cylinder 5a and the bucket cylinder 6a attached to the boom 4, the arm 5 and the bucket 6. Strain gauges 10, 11, 12 and 13 are applied to the cylinder rod 7. The strain gauges 10 and 11 are applied to parts of the cylinder rod 7 on the x-axis extending in the axial direction of the pin insertion hole shown in FIG. 3. The strain gauges 12 and 13 are applied to parts of the cylinder rod 7 on the z-axis which is orthogonal to the x-axis in the A-A′ cross section. The hydraulic cylinder carries out the driving by expanding and contracting the cylinder rod 7, and thus the cylinder rod 7 has a part that enters the inside of the cylinder. Therefore, it is desirable to apply the strain gauges 10, 11, 12 and 13 to the root of the clevis 8 such that the strain gauges 10, 11, 12 and 13 will not enter the inside of the hydraulic cylinder. In cases where the length of the cylinder rod 7 can be changed, it is possible to form a part that does not enter the inside of the hydraulic cylinder by increasing the length of the cylinder rod 7 and apply the strain gauges 10, 11, 12 and 13 to the part. With the strain gauges 10, 11, 12 and 13 applied to the cylinder rod 7, the stress and the load acting on the cylinder rod 7 are measured. In other words, the strain gauges 10, 11, 12 and 13 sense strain amounts of the cylinder rod 7.

Various types of loads such as a moment load and an impact load as well as the load in the compressive/tensile direction act on the cylinder rod 7 due to a wide variety of motions of the hydraulic excavator 100. The external force acting on the bucket 6 can be calculated precisely if the load in the compressive/tensile direction alone, among the multiple types of loads, can be selectively measured. Therefore, it is necessary to measure the load value of only the pure load in the axial direction of the cylinder rod 7 of the hydraulic excavator 100 by removing unnecessary loads such as the moment load acting on the cylinder rod 7. A method of calculating the load acting on the cylinder rod 7 by use of multiple sheets of strain gauges applied to the cylinder rod 7 will be explained below with reference to FIGS. 3 and 4 as a method for removing the moment load at times of swinging of the hydraulic excavator 100.

FIG. 3 is a cross-sectional view of the cylinder rod, in which four strain gauges 10, 11, 12 and 13 are applied to the cylinder rod as explained above. Values of these strain gauges during work with the hydraulic excavator 100 are taken into the load calculation section shown in FIG. 4.

FIG. 4 shows the flow (work flow) of a process performed in the load calculation section. The external force acting on the bucket of the hydraulic excavator 100 is calculated by using the load acting on the cylinder rod 7 calculated from the strain amounts of the cylinder rod 7. Measurement values of the strain gauges as information necessary for the process in the load calculation section 20 will be explained below. In FIG. 4, work with the hydraulic excavator 100 is started at the beginning. Subsequently, the strain amounts of the cylinder rod 7 are acquired by using the strain gauges 10, 11, 12 and 13. Subsequently, among the strain gauges 10, 11, 12 and 13, a set of opposing strain gauges that has the smaller strain amount is selected. Subsequently, the load acting on the cylinder rod 7 is calculated based on the selected strain amounts.

When a tensile load purely acts on the cylinder rod 7, all the strain gauges exhibit the same value. However, at times of swinging of the hydraulic excavator 100, the moment load acts on the cylinder rod 7, and thus there occurs a difference between the values of the strain gauges 10 and 11 (combination A) shown in FIG. 3. When there is a difference between the strain amounts of opposing strain gauges, an unnecessary load such as the moment load is included in the load. Therefore, a set of strain gauges that has the smaller values of the opposing strain gauges is selected from the two sets of strain gauges, and the values of the selected strain gauges are used. When the combination has been determined, the stress is calculated by taking the average of the values of the opposing strain gauges. By calculating the difference regarding each set of opposing strain gauges and using the values of the set having the smaller difference for the calculation of the load as above, the load in the axial direction alone, excluding the unnecessary loads such as the moment load and the impact load, can be calculated. The strain gauge is capable of calculating the stress and the load acting on the material by measuring the elongation of the material. In general, the stress working on the material can be calculated by dividing the load acting on the material by the cross-sectional area of the material. In cases where the stress is calculated from the strain amount of the material, dividing the Young's modulus as a material constant by the strain amount is a well-known method. External force acting on the cylinder rod 7 can be calculated based on the relationship of these values. After calculating the load acting on each hydraulic cylinder, the external force acting on the bucket 6 is calculated by the load calculation section 20 based on the posture of the hydraulic excavator 100. Values of the stroke sensors 4b, 5b and 6b attached to the hydraulic cylinders are used for calculating the posture of the hydraulic excavator 100.

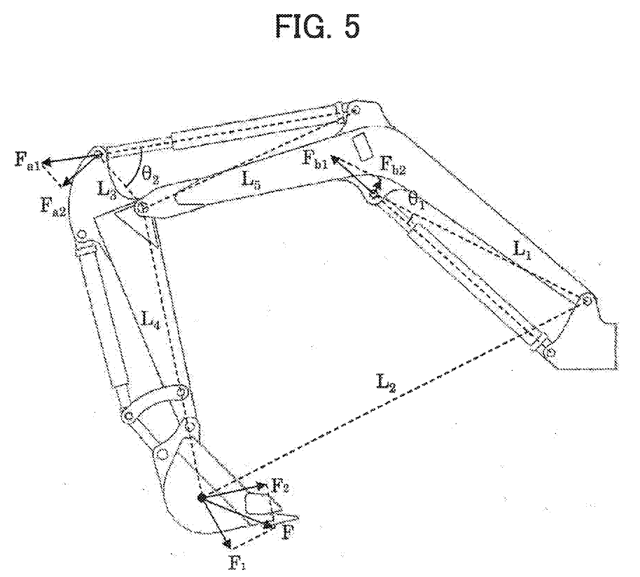

The external force acting on the bucket will be explained below with reference to FIG. 5. FIG. 5 is an enlarged view of the excavator front unit. Since the arm 5 is attached to the tip end of the boom 4 and the bucket 6 is attached to the tip end of the arm 5, the external force F₁ acting on the bucket 6 is calculated while assuming that the moment around the root of the boom 4 and an external force component acting on the bucket 6 are equal to each other. The external force acting on the bucket 6 will be explained below by using FIG. 5.

Based on equilibrium of moments around the root of the boom 4, the following expressions (1) and (2) hold, where L₁ represents the distance from the root of the boom 4 to the tip end of the boom cylinder 4a, L₂ represents the distance from the root of the boom 4 to the barycenter of the bucket 6, F_{b1} represents a load on the boom cylinder 4a, F_{b2} represents a load due to the moment around the root of the boom 4, and θ₁ represents an angle formed by L₁ and the boom cylinder 4a:

L₁F_{b2}+L₂F₁=0 (1)

F₁=−(L₁/L₂)F_{b2}=−(L₁/L₂)F_{b1} sin θ₁ (2)

L₁ is a fixed value specific to each machine. The distance L₂ to the barycenter is calculated by using the dimension of each part of the boom 4, the arm 5 and the bucket 6. θ₁ can be calculated from the distance between the root of the boom 4 and the root of the boom cylinder 4a and the distances L₁ and L₂ by using the law of cosines. The expression (1) is the equilibrium equation of the moments around the root of the boom 4. The expression (2) is an equation obtained by modifying the expression (1). F₁ as a component of the external force acting on the tip end of the bucket 6 can be calculated by using the expression (2).

Next, equilibrium of moments around the root of the arm 5 is represented by the following expressions (3) and (4), where L₃ represents the distance from the tip end of the boom 4 to the tip end of the arm cylinder 5a, L₄ represents the distance from the tip end of the boom 4 to the barycenter of the bucket 6, Fₐ₁ represents a load on the arm cylinder 5a, and Fₐ₂ represents a load due to the moment around the arm cylinder 5a:

L₃Fₐ₂+L₄F₂=0 (3)

F₂=−(L₃/L₄)Fₐ₂=−(L₃/L₄)Fₐ₁ sin θ₂ (4)

L₃ is a fixed value specific to each machine. L₄, as the distance from the tip end of the boom 4 to the barycenter of the bucket 6, is calculated from the dimension of each part similarly to L₂. θ₂ is also calculated by using the law of cosines similarly to θ₁. For the calculation of θ₂, the value of the arm stroke sensor 5b and values of L₃ and L₅ are used. L₅, representing the distance from the root of the arm cylinder 5a to the tip end of the boom 4, is a fixed value specific to each machine.

F₁ calculated by using the above expressions (1) to (4) is external force calculated from the moments around the boom 4, while F₂ is external force calculated from the moments around the arm 5. The external force F acting on the bucket 6 can be obtained by combining F₁ and F₂.

The method of calculating the external force is not limited to the above-described method; the external force can also be calculated by solving equations of motion regarding joints of the front unit of the hydraulic excavator 100. With the configuration described above, the load value of the pure load in the rod axial direction alone can be selectively measured by removing the unnecessary loads such as the moment load from the external force acting on the cylinder rod 7, which makes it possible to precisely calculate the external force acting on the tip end of the bucket 6 of the hydraulic excavator 100.

### Second Embodiment

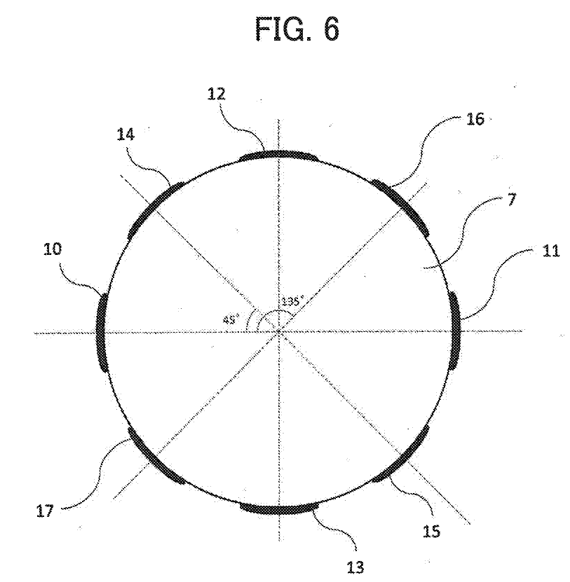

In the following embodiment, a method of calculating the external force acting on the bucket of the hydraulic excavator in a case where the number of the strain gauges in the first embodiment is increased to eight will be explained with reference to FIGS. 4 and 6. FIG. 4 shows the flow of a process performed in the external force calculation device, which is the same as that in the first embodiment. FIG. 6 is a cross-sectional view of a cylinder rod, in which strain gauges 14, 15, 16 and 17 are applied to the cylinder rod at positions at 45°, 135°, 225° and 270° with respect to the x-axis in addition to the strain gauges shown in FIG. 3.

In the first embodiment, the load was calculated by using the values of the opposing strain gauges having the smaller difference. However, there is a possibility that a precise load cannot be calculated when the difference between the values of two gauges is small or when a value smaller or larger than a previously assumed strain amount is outputted. In cases where such an abnormality occurs, the calculation of a precise load is made possible by increasing the number of strain gauges. The selection of strain gauges is made similarly to the first embodiment. Namely, the difference is calculated for each set of strain gauges and the values of the set of strain gauges having the smallest difference are used for the load calculation. The combination of the strain gauges used for calculating the load is not limited to opposing strain gauges; it is also possible to take the average of the values of all strain gauges applied to the cylinder rod and use the average for the load calculation. In other words, the following configuration may be employed: An external force measurement system for a work machine includes a hydraulic cylinder for driving a front unit of the work machine and a plurality of strain gauges for sensing strain amounts of a cylinder rod of the hydraulic cylinder. The plurality of strain gauges are formed of at least two sets of strain gauges. The at least two sets of strain gauges are arranged to oppose each other as viewed in an axial direction of the cylinder rod. The external force measurement system includes a load calculation section that is configured to calculate a load acting on the hydraulic cylinder based on an average value of the strain amounts of the at least two sets of strain gauges. With such a configuration, the external force acting on the bucket 6 of the hydraulic excavator 100 can be calculated stably even when an abnormal value is measured by a strain gauge.

### DESCRIPTION OF REFERENCE CHARACTERS

1: Lower track structure
2: Upper swing structure
3: Cab
4: Boom
4a: Boom cylinder
4b: Boom stroke sensor
5: Arm
5a: Arm cylinder
5b: Arm stroke sensor
6: Bucket
6a: Bucket cylinder
6b: Bucket stroke sensor
7: Cylinder rod
8: Clevis
9: Clevis
10: Strain gauge
11: Strain gauge
12: Strain gauge
13: Strain gauge
14: Strain gauge
15: Strain gauge
16: Strain gauge
17: Strain gauge
20: Load calculation section

1. An external force measurement system for a work machine, comprising:
a hydraulic cylinder for driving a front unit of the work machine; and
a plurality of strain gauges for sensing strain amounts of a cylinder rod of the hydraulic cylinder, wherein
the plurality of strain gauges are formed of at least two sets of strain gauges,
the at least two sets of strain gauges are arranged to oppose each other as viewed in an axial direction of the cylinder rod, and
the external force measurement system includes a load calculation section that is configured to calculate a load acting on the hydraulic cylinder based on difference between the strain amounts of the strain gauges arranged to oppose each other in each set.

2. An external force measurement system for a work machine, comprising:
a hydraulic cylinder for driving a front unit of the work machine; and
a plurality of strain gauges for sensing strain amounts of a cylinder rod of the hydraulic cylinder, wherein
the plurality of strain gauges are formed of at least two sets of strain gauges,
the at least two sets of strain gauges are arranged to oppose each other as viewed in an axial direction of the cylinder rod, and
the external force measurement system includes a load calculation section that is configured to calculate a load acting on the hydraulic cylinder based on an average value of the strain amounts of the at least two sets of strain gauges.

3. A work machine comprising:
a hydraulic cylinder for driving a front unit of the work machine; and
a plurality of strain gauges for sensing strain amounts of a cylinder rod of the hydraulic cylinder, wherein
the plurality of strain gauges are formed of at least two sets of strain gauges, and
the at least two sets of strain gauges are arranged to oppose each other as viewed in an axial direction of the cylinder rod.

4. The work machine according to claim 3, comprising a load calculation section that is configured to calculate a load acting on the hydraulic cylinder based on difference between the strain amounts of the strain gauges arranged to oppose each other in each set.

5. The work machine according to claim 3, wherein
the hydraulic cylinder is provided with a clevis, and
the plurality of strain gauges are applied to a root of the clevis.
